(19) United States
(12) Patent Application Publication
(10) Pub. No.: US 2009/0250987 A1
(43) Pub. Date: Oct. 8, 2009

(54) MOTOR VEHICLE SEAT HAVING LOCKABLE WING REST AND SEATING CONFIGURATION HAVING SUCH A MOTOR VEHICLE SEAT

(75) Inventor: Jurgen MAIER, Weitersweiler (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/419,848

(22) Filed: Apr. 7, 2009

(30) Foreign Application Priority Data
Apr. 8, 2008 (DE) 102008017712.1

(51) Int. Cl. B60N 2/01; B60N 2/20; B60N 2/46

(52) U.S. Cl. 297/257; 297/378.1; 297/232

(57) ABSTRACT

A motor vehicle seat is provide that includes, but is not limited to a backrest which is pivoted from an essentially upright usage position into an essentially horizontal non-usage position, the backrest having a wing rest which is pivotable in the non-usage position of the backrest from an armrest non-usage position, which is essentially parallel to a middle backrest par of the backrest, around the pivot axis into an armrest usage position to implement an armrest, and having a locking configuration which is lockable in two positions and by which the wing rest is lockable in both the armrest usage position and also the armrest non-usage position.

### CROSS-REFERENCE TO RELATED APPLICATION

This application claims priority to German Patent Application No. 102008017712.1, filed Apr. 8, 2008, which is incorporated herein by reference in its entirety.

### TECHNICAL FIELD

The present invention relates to a motor vehicle seat having a backrest, which may be pivoted from an essentially upright usage position into an essentially horizontal non-usage position, the backrest having at least one wing rest, which may be pivoted in the non-usage position of the backrest from a lower armrest non-usage position into an upper armrest usage position to implement an armrest, as well as a seating configuration having such a motor vehicle seat.

### BACKGROUND

Motor vehicle seats having a backrest are known from EP 0 943 482 B1, the backrest being able to be pivoted forward from a usage position into a non-usage position. The backrest has wing rests situated laterally on a middle backrest part, which may be pivoted from a lower armrest non-usage position around a pivot axis, which extends in the seat direction, into an upper armrest usage position, if the backrest is located in the non-usage position. In the upper armrest usage position, the wing rests are used as an armrest for adjacent motor vehicle seats within the same row of seats.

The wing rests engage in this armrest usage position by lowering a guide pin, which is guided in a curve guide during pivoting, into a catch recess of the curve guide and thus prevents pivoting back into the armrest non-usage position. To pivot it back, the wing rest must correspondingly be raised, which impairs the handling ability. It is also not locked in the armrest non-usage position, but rather is only supported on one side using its lever arm on the middle backrest part.

The known motor vehicle seat has proven itself. However, in the non-locked armrest non-usage position, undesired pivoting of the wing rests may occur. In addition, the disengagement of the locking in the armrest usage position is cumbersome.

It is therefore at least one object of the present invention to improve a motor vehicle seat of the type according to the species and/or a seating configuration having such a motor vehicle seat. In addition, other objects, desirable features, and characteristics will become apparent from the subsequent summary and detailed description, and the appended claims, taken in conjunction with the accompanying drawings and this background.

### SUMMARY

A motor vehicle seat according to an embodiment of the invention comprises a backrest, which is pivotable from an essentially upright usage position into an essentially horizontal non-usage position. The backrest has at least one, preferably two, wing rests, which, in the non-usage position of the backrest, are pivotable from an armrest non-usage position, in which they are situated essentially parallel to a middle backrest part of the backrest, around a pivot axis into an armrest usage position, in which they implement an armrest.

Furthermore, a motor vehicle seat according to an embodiment of the invention comprises a locking configuration, which is lockable in at least two positions, and using which at least one wing rest is lockable both in the armrest usage position and also in the armrest non-usage position. A rotation limiter is particularly also identified as a locking unit in this case, which delimits both further pivoting and also pivoting back out of the armrest usage position or armrest non-usage position to a predefined, preferably slight play.

In contrast to the wing rests of EP 0 943 482 B1, which are only lockable in the armrest usage position, undesired pivoting may thus be prevented in both defined rest positions.

This is advantageous in particular if the wing rest is preloaded elastically, for example, by one or more torsion bar springs and/or leg springs, around the pivot axis into an intermediate position, which lies between the armrest usage position and the armrest non-usage position and essentially halves the pivot pathway between these two positions, for example. In this way, the pivot pathway to be actively overcome for pivoting into one of the two rest positions (i.e., the armrest usage position or the armrest non-usage position), is advantageously decreased.

In another preferred embodiment, the wing rest may also be elastically preloaded in the armrest usage position or the armrest non-usage position in the same way, because it is lockable in these two rest positions, so that the locking counteracts the preloading on the one hand and prevents undesired pivoting out of the non-preloaded rest position on the other hand. Preloading in the armrest non-usage position makes the pivoting of the backrest into the usage position easier, while preloading in the armrest usage position simplifies the assumption of the non-usage position.

In a first embodiment of the present invention, the locking configuration has at least one or more first rotary catch locks for locking the wing rest in one of the armrest usage position and the armrest non-usage position and one or more second rotary catch locks for locking the wing rest in the other of the armrest usage position and the armrest non-usage position.

A rotary catch lock generally comprises a bolt which is connected to one of the wing rests and the middle backrest part, as well as a recess, which is secured using at least one hook, and which is situated on the other of the wing rests and the middle backrest part. For locking, the bolt is guided in a locking direction past the hook, which pivots back, into the recess until the hook snaps back, engages behind the bolt, and thus prevents a backward movement opposite to the locking direction as a stop. On the other hand, the recess delimits a further movement of the bolt in the locking direction as a stop.

One or more of these bolts may be situated essentially perpendicular to the pivot axis, for example. However, one or more bolts are preferably situated essentially parallel to the pivot axis of the wing rest, which allows an especially favorable engagement movement and a low overall height.

A hook of a rotary catch lock may be spring-loaded, so that it is pivoted away against an elastic preload by the bolt which is guided past and it is forced back into the locking position, which engages behind the hook, by this elastic preload. A spring-loaded locking rotary catch lock of this type is easy and reliable to lock.

In a second embodiment of the present invention, the locking occurs in the other of the armrest usage position and the armrest non-usage position in that the wing rest, which is mounted so it is axially displaceable in the direction of the pivot axis on the middle backrest part of the backrest, is axially displaced into the other of the armrest usage position and the armrest non-usage position in such a way that it is locked in a formfitting way on the middle backrest part, in particular engages using one or more axial projections and/or recesses in corresponding recesses or projections, respectively, in the middle backrest part.

The wing rest is preferably axially spring-loaded, so that it is forced into formfitting engagement with the middle backrest part by an elastic preload as soon as the wing rest has reached the other of the armrest usage position and the armrest non-usage position, and must first be axially displaced against this preload in order to be pivoted out of this other position. A spring-loaded locked locking configuration of this type is also easy and reliable to lock.

In a third embodiment of the present invention, the locking configuration has one or more bolt locks, in order to lock the wing rest in the armrest usage position and the armrest non-usage position.

A bolt lock generally comprises a bolt, which is implemented as rotationally fixed with one of the middle backrest part and the wing rest, having at least one protrusion which is adjustable between a position in which it protrudes radially beyond the outer circumference of the bolt and a position in which it is flush with the outer circumference or is offset radially inward in relation thereto. In the radially protruding position, the protrusion may engage in a corresponding depression in the other of the middle backrest part and the wing rest and thus connect middle backrest part and wing rest to one another rotationally fixed.

For locking, one or more of these protrusions engage in first depressions in the other of the middle backrest part and the wing rest in the armrest usage position, and in second depressions in the armrest non-usage position. The same protrusion may engage in both the first and the second depressions, which advantageously reduces the production outlay and installation space of the locking configuration. However, this is not absolutely necessary, first protrusions may also engage in the first depressions and other, second protrusions may engage in the second depressions, the particular non-engaging protrusions being situated in their position offset radially inward.

The radially movable protrusions may also advantageously be spring-loaded and thus may be forced into the first and/or second depressions by the elastic preload upon reaching the armrest usage position or armrest non-usage position. A spring-loaded locked locking configuration of this type is again easy and reliable to lock.

To make the locking easier and in particular to compensate for certain position tolerances, it is preferable for the radially protruding protrusions to have a conical or chamfered tip.

Additionally or alternatively to the elastic preload in the armrest usage position, the armrest non-usage position, or the intermediate position, a damper may be provided for damping a pivot movement of the wing rest, which advantageously decreases the strain on the locking configuration delimiting the pivot movement and increases the operational reliability because of the slower pivoting speed.

The locking configuration may preferably only be actively unlocked, in that a hook of a rotary catch lock is actively pivoted away or a protrusion of a bolt lock is actively retracted into its position offset radially inward, for example. Active unlocking is generally designed in such a way that it only unlocks in the event of a force exerted thereon, such as a manually applied traction or pressure force, and locks again when this force is discontinued, which may be implemented by a spring preloaded in the locked state, for example. In this way, undefined states are avoided and the locking configuration is always in the locked state without acting actuating force.

An unlocking actuator may particularly be provided for unlocking such a locking configuration, using which a traction or pressure force may be applied to the locking configuration, such as a hook of a rotary catch lock or a protrusion of a bolt lock, and/or such an element may be adjusted. Such an unlocking actuator may comprise a pushbutton, a rotary knob, or a handle, for example, which actuates the locking configuration via a corresponding mechanism, such as a Bowden cable, a lever mechanism, a gear, or the like, or electronically using corresponding electric motors or electromagnets.

Such a locking actuator is preferably situated on the middle backrest part and/or the wing rest, in particular on the head area of the middle backrest part or the wing rest, because it is very well accessible there.

As noted above, the motor vehicle seat preferably has a further wing rest, which is also pivotable between an armrest non-usage position and an armrest usage position. This wing rest may be kinematically coupled to the one wing rest explained in greater detail above in such a way that it is pivoted between the armrest non-usage position and the armrest usage position by pivoting of this wing rest. Such a forced coupling may be implemented mechanically, for example, via Bowden cables, multiple joints, and/or curve guides, for example. Because of such a forced coupling, the further wing rest is also advantageously locked in the armrest usage position or in the armrest non-usage position when the locking configuration is locked in the armrest usage position or armrest non-usage position, respectively.

A seating configuration according to an embodiment of the invention has a motor vehicle seat of the above-mentioned type and at least one second motor vehicle seat, which are situated adjacent to one another in a row of seats, a wing rest being situated on the side facing toward the second motor vehicle seat. The wing rest may thus be used to implement an armrest for the second motor vehicle seat. Furthermore, the second motor vehicle seat may be displaced further inward after the wing rest is pivoted into the armrest usage position, in order to decrease the overall width of the row of seats.

Furthermore, in a preferred embodiment of a seating configuration according to the invention, a third motor vehicle seat is provided in the row of seats, the motor vehicle seat of the above-mentioned type being situated between the second and third motor vehicle seats. One wing rest may thus be used to implement an armrest for the second motor vehicle seat and another wing rest may be used to implement an armrest for the third motor vehicle seat.

To provide an especially flexibly adaptable seating configuration, the second and/or third motor vehicle seats are displaceable inward in the transverse direction in an especially preferred embodiment of the seating configuration in such a way that they at least partially extend into the free space which was provided by pivoting the wing rest from the armrest non-usage position into the armrest usage position. As already explained at the beginning, in this way the overall width of the row seats may be reduced, so that the seats may be moved to the rear into a so-called lounge position, even if the width of the motor vehicle interior is decreased to the rear.

In an especially preferred embodiment of the seating configuration according to an embodiment of the invention, motor vehicle seats of the seating configuration may be displaced in the seat direction independently of one another.

### BRIEF DESCRIPTION OF THE DRAWINGS

The present invention will hereinafter be described in conjunction with the following drawing figures, wherein like numerals denote like elements, and:

FIG. 1 shows a front view of a seating configuration having a motor vehicle seat according to one embodiment of the present invention having the backrest in the usage position;

FIG. 2 shows the seating configuration from FIG. 1 having the backrest in the non-usage position;

FIG. 3 shows the seating configuration of FIG. 2 having the wing rest in the armrest usage position;

FIG. 4 shows the seating configuration of FIG. 3 having second and third motor vehicle seats displaced inward in the transverse direction;

FIGS. 5A, B show a part of a locking configuration of the motor vehicle seat from FIG. 3 according to a first embodiment of the present invention in the armrest non-usage position (FIG. 5A) and the armrest usage position (FIG. 5B);

FIGS. 6A, 6B show a part of a locking configuration of the motor vehicle seat of FIG. 3 according to a second embodiment of the present invention in the armrest non-usage position (FIG. 6A) and the armrest usage position (FIG. 6B);

FIGS. 7A, 7B show the locking configuration of FIG. 6 in horizontal projection from above; and

FIGS. 8A, 8B show a part of a locking configuration of the motor vehicle seat from FIG. 3 according to the third embodiment of the present invention in the armrest non-usage position (FIG. 8A) and the armrest usage position (FIG. 8B).

### DETAILED DESCRIPTION

The following detailed description is merely exemplary in nature and is not intended to limit application and uses. Furthermore, there is no intention to be bound by any theory presented in the preceding background and summary or the following detailed description.

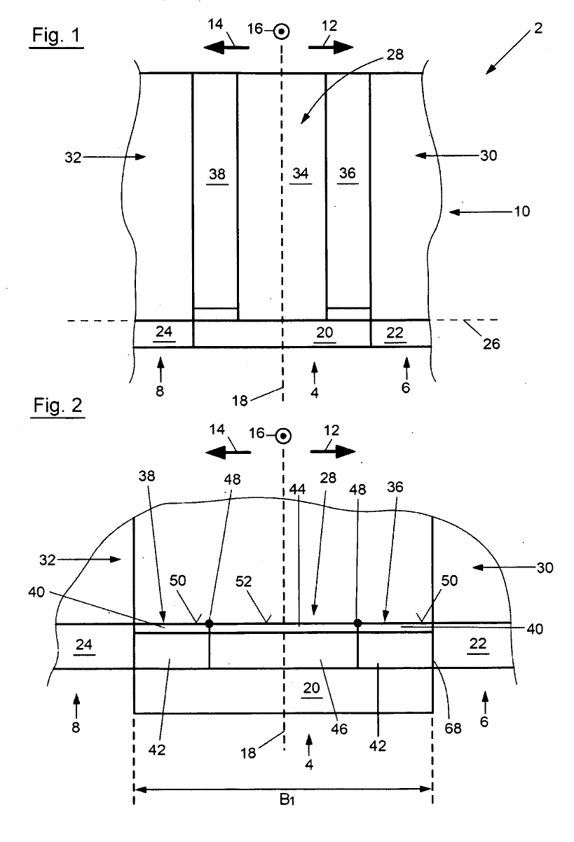

FIG. 1 shows a front view of a seating configuration 2 according to an embodiment of the invention. The seating configuration 2 comprises a middle or first motor vehicle seat 4, a second motor vehicle seat 6, and a third motor vehicle seat 8, which are situated adjacent to one another in a row of seats 10. The second motor vehicle seat 6 is situated adjacent to the first motor vehicle seat 4 in the first transverse direction 12, while the third motor vehicle seat 8 is situated adjacent to the first motor vehicle seat 4 in the opposite second transverse direction 14. The seat direction 16 is identical for all motor vehicle seats 4, 6, 8 and corresponds to the normal of the drawing page in FIG. 1. In addition, the vertical direction 18 of the seating configuration 2 or the motor vehicle seats 4, 6, 8 is indicated by a dashed vertical axis in FIG. 1. All three motor vehicle seats 4, 6, 8 may be displaced in the seat direction 16 or opposite to the seat direction 16 independently of one another.

The first motor vehicle seat 4 represents an embodiment of the motor vehicle seat according to the invention, while the motor vehicle seats 6, 8 may be typical motor vehicle seats. Alternatively, however, the second and third motor vehicle seats 6, 8 may also be implemented like the first motor vehicle seat 4. All motor vehicle seats 4, 6, 8 each comprise a seat part 20, 22, 24 and a backrest 28, 30, 32, which is situated on the particular seat part 20, 22, 24 so it is pivotable around a first pivot axis 26. The backrests 28, 30, 32 may be pivoted around the first pivot axis 26 independently of one another.

The backrest 28 of the first motor vehicle seat 4 is essentially composed of a middle backrest part 34 and two wing rests 36, 38 fastened laterally thereon. While the wing rest 36 is situated laterally in the transverse direction 12 on the middle backrest part 34 and thus facing toward the second motor vehicle seat 6, the wing rest 38 is situated laterally in the transverse direction 14 on the middle backrest part 34 and thus facing toward the third motor vehicle seat 8.

The backrest 28 of the first motor vehicle seat 4 may be pivoted forward from an essentially upright usage position, which is shown in FIG. 1, around the first pivot axis 26 in the seat direction 16 into an essentially horizontal non-usage position, which is shown in FIG. 2. As is obvious from FIG. 2, the seat part 20 of the motor vehicle seat 4 sinks downward in the vertical direction 18 upon the pivot movement of the backrest 28 around the first pivot axis 26 far enough that the top side of the seat part 20 is situated below or on a level with the bottom side of the seat parts 22, 24 of the second and third motor vehicle seats 6, 8.

Furthermore, from FIG. 2 it can be seen that the wing rests 36, 38 are each composed of a plate-shaped support part 40 and a cushion part 42. Correspondingly, the middle backrest part 34 also has a plate-shaped support part 44 and a cushion part 46 situated thereon. The support part 40 of the wing rests 36, 38 is situated so it is pivotable around a second pivot axis 48 on the plate-shaped support part 44 of the middle backrest part 34. The support parts 40 each have a back 50, which implements the back of the backrest 28 in the usage position (FIG. 1) and the non-usage position (FIG. 2) of the backrest 28 together with a back 52 of the support part 44 of the middle backrest part 34.

In FIG. 2, the wing rests 36, 38 are located in a lower armrest non-usage position, in which the wing rests 36, 38 are situated essentially parallel to the middle backrest part 34. In the armrest non-usage position, the backs 50, 52 of the wing rests 36, 38 or the middle backrest part 34 are situated in one plane. Furthermore, the wing rests 36, 38 are disengageably locked in the armrest non-usage position in such a way that they cannot be pivoted around the second pivot axes 48. The locking mechanism for locking the wing rests 36, 38 in the armrest non-usage position is explained in greater detail hereafter.

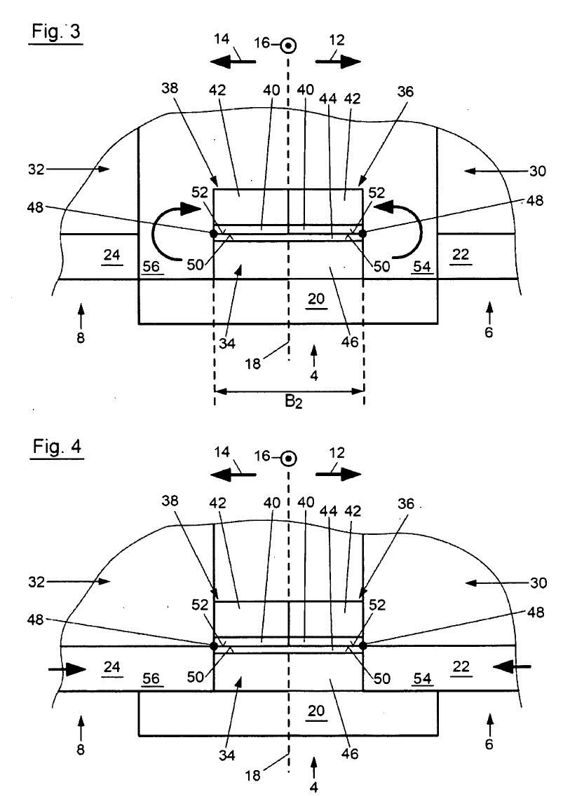

Starting from the lower armrest non-usage position (FIG. 2), the wing rests 36, 38 may be pivoted around the pivot axes 48, which extend in the seat direction 16, into an upper armrest usage position, as shown in FIG. 3. The wing rests 36, 38 are pivoted around about 180° from the armrest non-usage position into the armrest usage position shown in FIG. 3. In the upper armrest usage position, the cushion part 42 of the wing rests 36, 38 each implement an armrest for the second motor vehicle seat 6 or the third motor vehicle seat 8, respectively. After the pivoting around about 180°, the backs 50 of the support parts 40 of the wing rests 36, 38 are supported on the back 52 of the support part 44 of the middle backrest part 34.

The original width B1 of the backrest 28, which is indicated in FIG. 2, is decreased to a width B2, which is shown in FIG. 3, by the pivot movement. Therefore, B2<B1. As already noted, the seat part 20 is offset downward in the vertical direction 18 by the pivot movement of the backrest 28 around the first pivot axis 26, so that a free space 54 or 56 has resulted in the transverse direction 12 or 14, respectively, laterally to the middle backrest part 34. Because the two motor vehicle seats 6, 8 may be displaced in the transverse directions 12 and 14, it is not possible to displace the second motor vehicle seat 6 in the transverse direction 14 and the third motor vehicle seat 8 in the transverse direction 12 far enough inward that their seat part 22 or 24 extends into the particular free space 54 or 56, respectively, as indicated in FIG. 4. In this way, the motor vehicle seats 6, 8 may be situated closer to the associated armrest, so that the width of the row of seats 10 is decreased overall.

The wing rests 36, 38 are preloaded in the upper armrest usage position shown in FIG. 3 and FIG. 4. This has the advantage that the wing rests pivot automatically or independently out of the armrest non-usage position, shown in FIG. 2, around the pivot axes 48 into the armrest usage position shown in FIG. 3 and FIG. 4, as soon as the locking of the wing rests is canceled by the operator or the vehicle occupant. Because of the locking configuration, which is explained in greater detail hereafter, they may also be preloaded in the armrest usage position according to FIG. 2 or an intermediate position (not shown) between these positions, however, for example, a position pivoted by about 45°, about 90°, or about 135° toward the armrest non-usage position (FIG. 2) in the direction of the armrest usage position (FIG. 3).

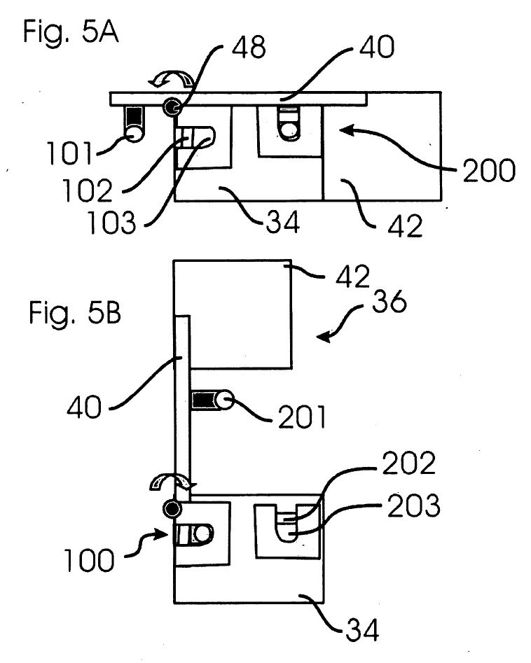

A locking configuration, which is provided in a motor vehicle seat according to a first embodiment of the present invention, as was described above with reference to FIG. 1 through FIG. 4, is explained in greater detail on the basis of FIGS. 5A, B. Only the essential elements of the locking configuration are shown for clarification. Notwithstanding FIG. 1 through FIG. 4, the wing rests 36, 38, of which only one wing rest 36 is explained in greater detail hereafter because of their symmetry, are pivoted from the armrest non-usage position by only about 90° into the armrest usage position and locked there.

In a partial detail corresponding to FIG. 3, FIG. 5 shows the middle backrest part 34, the cushion part 46 and the plate-shaped support part 44 being combined for simplification. The plate-shaped support part 40 of the wing rest 36 is pivotable around the second pivot axis 48, so that the wing rest 36, which comprises the cushion part 42 connected thereto in addition to the support part 40, is pivotable between the armrest non-usage position (FIG. 5A) and the armrest usage position (FIG. 5B).

The locking configuration comprises a first rotary catch lock 100 and a second rotary catch lock 200, which has an identical construction thereto. The first rotary catch lock 100 has a bolt 101, connected fixed to the support part 40, whose axis is parallel to the pivot axis 48, and a U-shaped recess 103, secured by a hook 102, which is situated in the middle backrest part 34 in the form of a sheet-metal guide and may accommodate the bolt 101. The hook 102 is preloaded by a spring (not shown) in the position shown in FIG. 5A, in which it closes the recess 103.

Upon pivoting of the wing rest 36 out of the armrest non-usage position (FIG. 5A) into the armrest usage position (FIG. 5B), the bolt 101 is inserted into the recess 103 in a locking direction (from left to right in FIG. 5B) and pivots the hook 102 away against its spring preloading (counterclockwise upward in FIG. 5) at the same time. After the bolt 101 has passed the hook 102 and is completely accommodated in the recess 103, the hook 102 pivots back into the position shown in FIG. 5B because of the spring preload, engages behind the hook 102, and thus prevents the hook 102 from sliding out opposite to the locking direction. Because, on the other hand, the U-shaped recess 103 prevents a further movement of the bolt 101 in the locking direction, the wing rest 36 is locked with the bolt 101 in the armrest usage position.

To disengage this locking, the user presses a first pushbutton (not shown), which is situated adjacent to a headrest on the head end of the middle backrest part 34. This pushbutton pivots the hook 102 away toward its spring preloading (counterclockwise upward in FIG. 5B) via a Bowden cable (not shown), until the bolt 101 may slide out of the recess 103 opposite to the locking direction (from right to left in FIG. 5B) and the wing rest 36 may thus pivot away out of its armrest usage position. If the manually applied actuating force on the first pushbutton is discontinued, the spring preloading forces the hook 102 back into the position blocking the recess 103.

The locking of the wing rest 36 in its armrest non-usage position (FIG. 5A) and the unlocking of this locking occur completely similarly via the second rotary catch lock 200: the second rotary catch lock 200 also has a bolt 201 connected fixed to the support part 40, whose axis is parallel to the pivot axis 48, and a U-shaped recess 203, secured by a hook 202, which is situated in the middle backrest part 34 in the form of a sheet-metal guide and may accommodate the bolt 201. The U-shaped recess 203 of the second rotary catch lock 200 is oriented orthogonally to the recess 103 of the first rotary catch lock. The hook 202 is also preloaded by a spring (not shown) in the position shown in FIG. 5A, in which it closes the recess 203.

Upon pivoting of the wing rest 36 out of the armrest usage position (FIG. 5B) into the armrest non-usage position (FIG. 5A), the bolt 201 is inserted into the recess 203 in a locking direction (from top to bottom in FIG. 5A) and pivots the hook 202 away toward its spring preloading (clockwise downward in FIG. 5A). After the bolt 201 has passed the hook 202 and is completely accommodated in the recess 203, the hook 202 pivots back into the position shown in FIG. 5A because of the spring preloading, engages behind the hook 202, and thus prevents the hook 202 from sliding out opposite to the locking direction. On the other hand, because the U-shaped recess 203 prevents a further movement of the bolt 201 in the locking direction, the wing rest 36 is locked with the bolt 201 in the armrest non-usage position.

To disengage this locking, the user presses a second pushbutton (not shown), which is also situated adjacent to a headrest and the first pushbutton on the head end of the middle backrest part 34. This pushbutton pivots the hook 202 away toward its preloading (clockwise downward in FIG. 5B) via a Bowden cable (not shown), until the bolt 201 may slide out of the recess 203 opposite to the locking direction (from top to bottom in FIG. 5A) and the wing rest 36 may thus be pivoted away out of its armrest non-usage position. If the manually applied actuating force on the second pushbutton is discontinued, the spring preloading forces the hook 202 back into the position blocking the recess 203.

In this way, in a way which is simple to produce and operate, and is reliable and space-saving, the wing rest 36 may be locked in the armrest usage position and the armrest non-usage position, and undesired pivoting may thus be prevented.

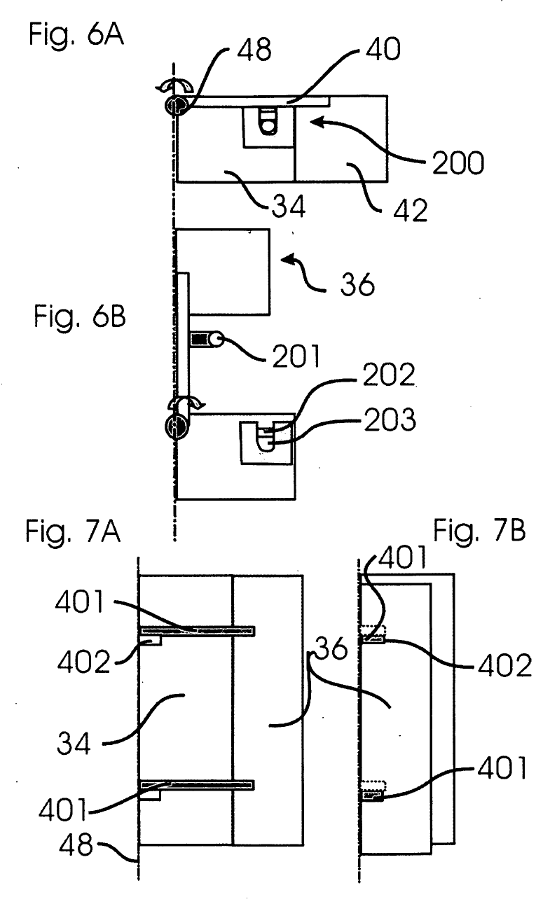

A locking configuration is explained in greater detail on the basis of FIGS. 6A, 6B, 7A, 7B, which is provided in a motor vehicle seat according to a second embodiment of the present invention, as was described above with reference to FIG. 1 through FIG. 4. Elements having identical constructions to the first embodiment are provided with the same reference numerals, so that reference is made to the preceding statements for their explanation and only the differences to the first embodiment are explained hereafter. FIGS. 6A, 6B correspond to the view of FIGS. 5A, 5B, while FIG. 7A shows the locking configuration of FIG. 6A in horizontal projection, and FIG. 7B correspondingly shows the locking configuration of FIG. 6B.

For locking in the armrest non-usage position, the locking configuration of the second embodiment has the rotary catch lock 200 described above. However, the locking is performed differently in the armrest usage position.

For this purpose, the wing rest 36 is fastened so it is axially movable in the direction of the second pivot axis 48 on the middle backrest part 34. Two legs 401 of the support part 40 are mounted so they are movable both rotationally and also axially on an axis connected fixed to the middle backrest part 34 for this purpose.

Depressions 402 (FIG. 7A) are provided in the middle backrest part 34 in such a way that they may accommodate these legs 401 only in the armrest usage position (FIG. 7B). The legs 401 are elastically preloaded axially in the direction of these depressions 402 by a compression spring (not shown), so that they may be forced into the depressions 402 in the armrest usage position by the compression spring and then prevent pivoting out of the armrest usage position in a formfitting way.

For locking in the armrest usage position, as described above with reference to FIG. 5, the rotary catch lock 200 is thus first unlocked and the wing rest is pivoted around the pivot axis 48 into the armrest usage position (FIGS. 6B, 7B). In this position, the compression spring presses the legs 401 into the depressions 402 and thus locks the wing rest 36 in a formfitting way in the armrest usage position. To disengage this locking and pivot the wing rest back into the armrest non-usage position, in which it is locked by the rotary catch lock 200, the user must only displace the wing rest 36 axially along its pivot axis 48 opposite to the compression spring until the legs 401 disengage from the depressions 402 and may be pivoted into the armrest non-usage position.

In this way, in a way which is simple to produce and operate, and is reliable and space-saving, the wing rest 36 may also be locked in the armrest usage position and the armrest non-usage position and undesired pivoting may thus be prevented.

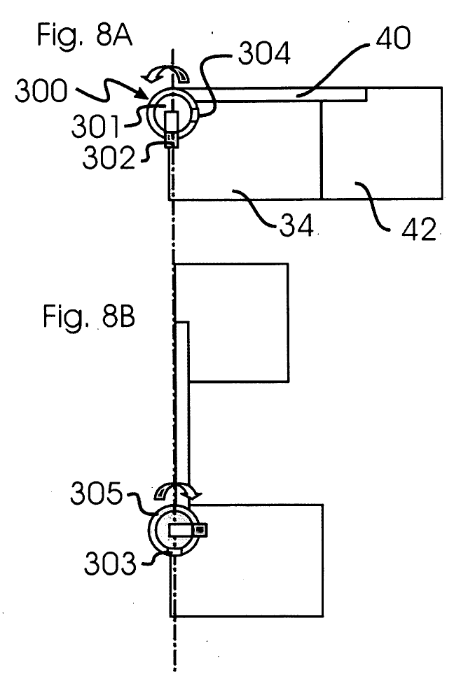

A locking configuration, which is provided in a motor vehicle seat according to a third embodiment of the present invention, as was described above with reference to FIG. 1 through FIG. 4, is explained in greater detail on the basis of FIGS. 8A, 8B. Elements having identical constructions to the first embodiment are provided with the same reference numerals, so that reference is made to the preceding statements for their explanation and only the differences to the first embodiment are explained hereafter. FIGS. 8A, 8B correspond to the view of FIGS. 5A, 5B, and 6A, 6B, respectively.

In contrast to the locking configuration having two rotary catch locks 100, 200 or one rotary catch lock 200 and an axially displaceable wing rest 36, the locking configuration of the third embodiment comprises a bolt lock 300, which is lockable in both the armrest non-usage position (FIG. 8A) and also the armrest usage position (FIG. 8B) so that production outlay and installation space may be reduced further.

For this purpose, the bolt lock 300 comprises a bolt 301, connected fixed to the middle backrest part 34, whose axis is aligned with the pivot axis 48, and which engages through an annular end 305 of the support part 40 of the wing rest 36, so that the wing rest 36 is mounted so it is pivotable on the bolt 301.

A radially displaceable protrusion 302 is mounted in the bolt 301 in such a way that it protrudes beyond the outer circumference of the bolt 301 in a spring-loaded way (not shown) and may be pressed inward into the bolt 301 into a position offset radially inward toward this spring preloading, so that it is flush with the outer circumference of the bolt 301.

Two depressions 303, 304, which are offset to one another around the circumference by about 90°, are implemented in the annular end 305 of the support part 40 in such a way that the protrusion 302, which protrudes beyond the outer circumference of the bolt 301, has its conical tip engaging through a depression 303 if the wing rest 36 is in its armrest non-usage position (FIG. 8A), and engages through the other depression 304 if the wing rest 36 is in its armrest usage position (FIG. 8B).

If the spring-loaded protrusion 302 engages through one of the depressions 303, 304, it locks the support part 40 via the annular end 305 and thus locks the wing rest 36 rotationally fixed on the middle backrest part 34. To disengage the locking in the armrest usage position or the armrest non-usage position, the user presses a pushbutton, as was described with reference to the first embodiment. This pushbutton pulls the protrusion 302 radially inward below the outer circumference of the bolt 301 via a Bowden cable (not shown) so that the annular end 305 may be rotated on the bolt 301. When the actuating force is no longer applied to the pushbutton, the spring loads the protrusion 302 radially outward again, so that it engages in one of the depressions 303, 304 as soon as it is aligned therewith. In this way, both the armrest non-usage position and also the armrest usage position may be actively unlocked using only one pushbutton.

In this way, in a way which is simple to produce and operate, and is reliable and space-saving, the wing rest 36 may also be locked in the armrest usage position and the armrest non-usage position and undesired pivoting may thus be prevented.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle seat, comprising:
a backrest which is pivotable from an essentially upright usage position into an essentially horizontal non-usage position;
a wing rest which is pivotable in a non-usage position of the backrest from an armrest non-usage position, which is essentially parallel to a middle backrest part of the backrest around a pivot axis into an armrest usage position to implement an armrest; and
a locking configuration which is lockable in at least two positions, and by which the wing rest is lockable in both the armrest usage position and also the armrest non-usage position.

2. The motor vehicle seat according to claim 1, wherein the locking configuration has at least one first rotary catch lock for locking the wing rest in one of the armrest usage position or the armrest non-usage position.

3. The motor vehicle seat according to claim 2, wherein the locking configuration has at least one second rotary catch lock adapted to lock the wing rest in the other of the armrest usage position or the armrest non-usage position.

4. The motor vehicle seat according to claim 2, wherein the wing rest is mounted so it is axially displaceable in a direction of the pivot axis on the middle backrest part of the backrest in such a way that it is lockable in a formfitting way on the middle backrest part in the other of the armrest usage position or the armrest non-usage position.

5. The motor vehicle seat according to claim 2, wherein a bolt of a rotary catch lock is at least situated in one of an essentially parallel or perpendicular position relative to the pivot axis.

6. The motor vehicle seat according to claim 1, wherein the locking configuration has at least one bolt lock adapted to lock the wing rest in at least one of the armrest usage position or the armrest non-usage position.

7. The motor vehicle seat according to claim 6, wherein a bolt lock has a bolt that is rotationally fixed in one of the middle backrest part or the wing rest, having at least one radially movable protrusion that engages in a first depression in the other of the middle backrest part or the wing rest in the armrest usage position and engages in a second depression in the other of the middle backrest part and the wing rest in the armrest non-usage position.

8. The motor vehicle seat according to claim 7, wherein at least one of a radially protruding or intrusion has at least one of conical or chamfered tip.

9. The motor vehicle seat according to claim 1, wherein the locking configuration is lockable in a spring-loaded way in at least one of the armrest usage position or the armrest non-usage position.

10. The motor vehicle seat according to claim 1, wherein the wing rest is elastically preloaded by at least one of a torsion bar spring or leg spring, in at least one of the armrest usage position, the armrest non-usage position, or an intermediate position.

11. The motor vehicle seat according to claim 1, further comprising a damper adapted to dampen a pivot movement of the wing rest.

12. The motor vehicle seat according to claim 1, further comprising an unlocking actuator adapted for unlocking the locking configuration.

13. The motor vehicle seat according to claim 12, wherein a locking actuator is situated on at least one of the middle backrest part or the wing rest.

14. The motor vehicle seat according to claim 1, further comprising a second wing rest that is kinematically coupled to the wing rest in such a way that it is pivotable thereby between the armrest non-usage position and the armrest usage position and is lockable by the locking configuration in both the armrest usage position and also the armrest non-usage position.

15. A seating configuration, comprising:
a first motor vehicle seat, comprising:
a backrest which is pivotable from an essentially upright usage position into an essentially horizontal non-usage position;
a wing rest which is pivotable in a non-usage position of the backrest from an armrest non-usage position, which is essentially parallel to a middle backrest part of the backrest around a pivot axis into an armrest usage position to implement an armrest; and
a locking configuration which is lockable in at least two positions, and by which the wing rest is lockable in both the armrest usage position and also the armrest non-usage position; and
a second motor vehicle seat situated adjacent to the first motor vehicle seat in a row of seats,
wherein the wing rest is situated on a side of the first motor vehicle seat facing toward the second motor vehicle seat.

16. The seating configuration according to claim 17, further comprising a third motor vehicle seat in the row of seats, at least one of the second motor vehicle seat or third motor vehicle seat displaceable inward in the transverse direction in such a way that at least partially extend into a free space provided by a pivoting the wing rest from the armrest non-usage position into the armrest usage position.
